(19) United States
(12) Patent Application Publication
(10) Pub. No.: US 2006/0031439 A1
(43) Pub. Date: Feb. 9, 2006

(54) Method and apparatus for network management

(76) Inventor: Fabrice TP Saffre, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 10/530,472

(22) PCT Filed: Oct. 21, 2003
(86) PCT No.: PCT/GB03/04533

§ 371 Date: Apr. 6, 2005

(30) Foreign Application Priority Data
Oct. 29, 2002 (GB) 0225139.5
Feb. 17, 2003 (GB) 0303598.7

(51) Int. Cl. G06F 15/173

(52) U.S. Cl. 709/223

(57) ABSTRACT

A network, and a method and apparatus for network management are disclosed in which nodes in the network are arranged specified number of connections with other nodes by initiating links across the network tree structure to nodes on the same level in the hierarchical tree. As a result, nodes are linked to their sibling nodes in addition to being linked to parent and child nodes

The present invention relates to networks, in particular but not exclusively to computer or communications networks. The invention is particularly applicable in the organisation of network topology (connections).

It is known to share computer and other network resources (disk space, CPU time etc.) over a network. This arrangement enables a large group of simple devices with limited individual capabilities to provide an alternative to dedicated computers. One example of sharing resources is a distributed computing application known as “grid computing” which enables the harnessing of the power of numerous networked machines scattered over distant geographical locations so as to be able to provide services on demand. These services may be provided using resources that would otherwise be under utilised. These grid computing arrangements can provide massive computing power at relatively low cost.

Other applications of distributed computing involve the connection of large numbers of low cost (perhaps recycled) PCs at a single physical location to provide an efficient (if large) supercomputer. However, as with all applications of distributed computing techniques, they can only be successful if the speed of data transmission matches that of data processing. In other words, it makes no sense to decompose the entire process of solving a complex problem into many simpler tasks if it is not possible to deliver intermediate results at the right place and time for the next step to proceed. Similarly, even a very fast search in a huge distributed database is useless if the retrieved information encounters a bottleneck on its way back to the source of the query.

Distributed computing systems are likely to operate best if not built according to a predefined plan. Such systems work best when they are allowed to grow and they do so in a generally unpredictable fashion. Similarly, it is advantageous for supercomputers built out of lowend and/or recycled components to be capable of using any piece of hardware that becomes available. In both cases, the resulting network topology will be highly dynamic, where explicitly maintaining order (or even being able to discriminate between essential and non-essential components) will become impractical.

Current systems for sharing resources on a large scale such as in distributed computing systems that use non-specialised devices do not perform well when components of the system are removed, migrated or new components added. Often such activity requires a degree of redesign of the system architecture. Another problem with existing systems is that information flow can often become concentrated on components that are not well equipped to deal with such traffic thereby causing overloading.

Current systems for sharing resources on a large scale such as in distributed computing systems that use non-specialised devices do not perform well when components of the system are removed, migrated or new components added. Often such activity requires a degree of redesign of the system architecture. Another problem with existing systems is that information flow can often become concentrated on components that are not well equipped to deal with such traffic thereby causing overloading.

A known way of supporting network growth is to upgrade components when the increasing workload exceeds their capacity. This is only practical as far as bottlenecks can be clearly identified, meaning they have to be stable in space and time (recurrent problems at a precise location, e.g. the hub of a particularly busy cluster in a hierarchical structure). In a fully decentralised system, traffic becomes so diffuse that it is difficult to isolate points of maximum stress, and/or so dynamic that such points are not associated with any specific network element. In these circumstances, ad-hoc replacement policies are seldom successful.

According to a first aspect of the present invention, there is provided a node for a network, the network comprising a hierarchical structure in which a node is considered to be at a higher level than a parent node to which it connects when joining the network, the node being adapted to:

(a) maintain a primary connection to a node at a lower level in the network hierarchy;

(b) to attempt to maintain a specified number N of further connections between the node and other nodes in the network; and

(c) upon receipt of a request from a further node desiring to form its primary connection with the node, and in the event that none of the N connections of the node is unallocated, then to:
select one of the further connections which is not a primary connection for one of the other nodes; and
to re-allocate that selected further connection to the further node so as to form the primary connection for the further node.

According to a second aspect of the present invention, there is provided a method of operating a node in a network, the network comprising a hierarchical structure in which a node is considered to be at a higher level than a parent node to which it connects when joining the network, the method comprising:

(a) maintaining a primary connection to a node at a lower level in the network hierarchy;

(b) attempting to maintain a specified number N of further connections between the node and other nodes in the network; and

(c) upon receipt of a request from a further node desiring to form its primary connection with the node, and in the event that none of the N connections of the node is unallocated, then:
selecting one of the further connections which is not a primary connection for one of the other nodes; and
re-allocating that selected further connection to the further node so as to form the primary connection for the further node.

According to embodiments of the invention there is provided a novel network topology having connection rules allowing the network to grow to a desired size while respecting a set of constraints. The resulting network structure is one in which node degree is constant (all nodes have the same number of 1^{st} neighbours) and the workload on the most busy member(s) (in terms of traffic) typically grows as a logarithmic function of network size. This is achieved by cross-allocating unused links within each level of the tree, until they are needed to provide an access point for newcomers. The cross allocated links may serve as shortcuts between (topologically) distant parts of the network, reducing its diameter and average path length, while re-routing some of the traffic away from the more busy (central) nodes. It is understood that the network might relate either to a physical network or alternatively to some type of “virtual” overlay network formed on top of an earlier existing network.

Embodiments of the invention facilitate the addition, removal and migration of network components without the need for redesigning the entire architecture. This improves the robustness and plasticity of the network. Furthermore, information flow within the network is as homogeneously distributed as information processing so as to generally avoid a situation where a small sub-set of network elements become primary relays. This makes the network more scalable.

Embodiments of the invention will now be described with reference to the accompanying drawings in which:

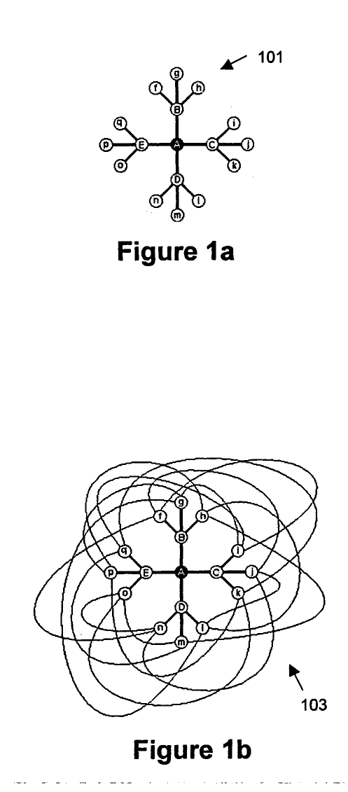

FIGS. 1a and 1b are schematic representations of a known network topology (tree) and a network according to an embodiment of the present invention respectively;

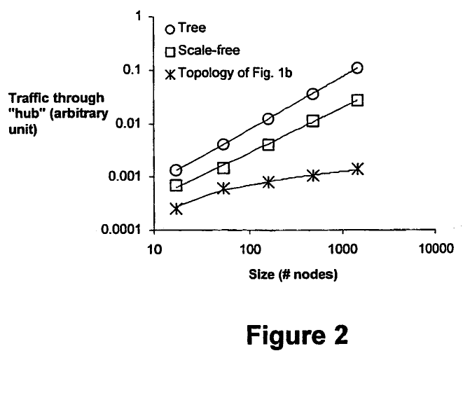

FIG. 2 is a graph illustrating the traffic flows within three different network topologies: a tree topology; the topology type of FIG. 1b; and a scale-free topology;

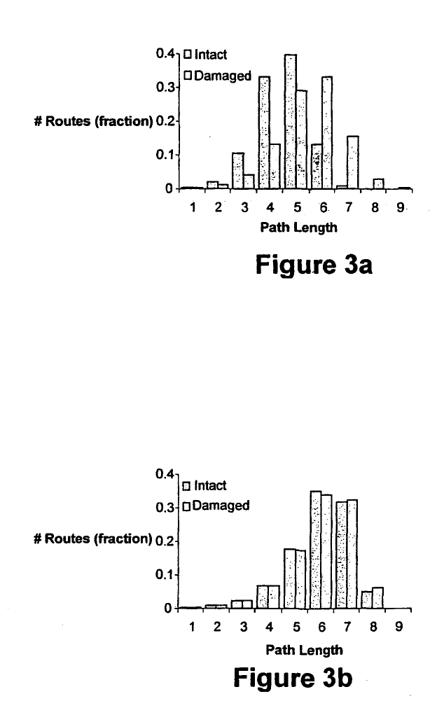

FIGS. 3a and 3b are graphs showing the performance of a scale-free network topology and the topology type in FIG. 1b respectively in response to directed attack;

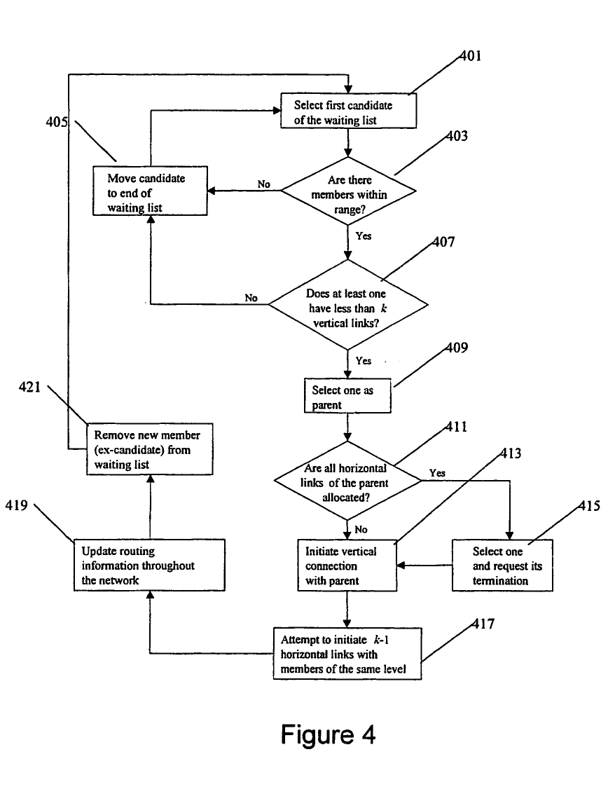

FIG. 4 is a flow chart illustrating the process carried out during the process of connecting nodes to a network in accordance with an embodiment of the invention;

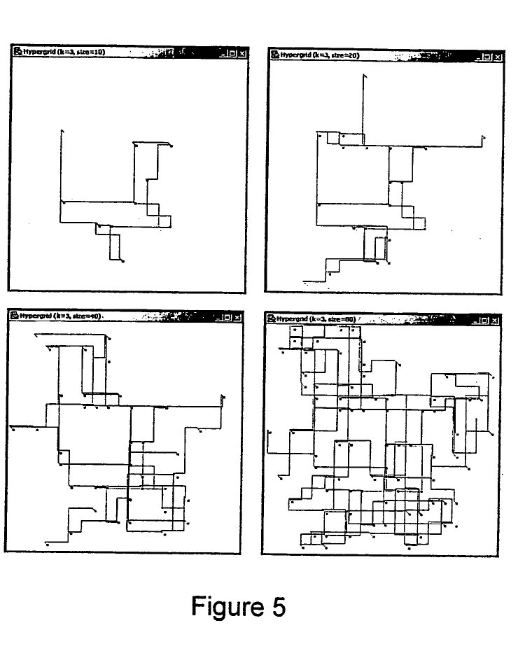

FIG. 5 is a schematic representation of a network being built using the process of FIG. 4;

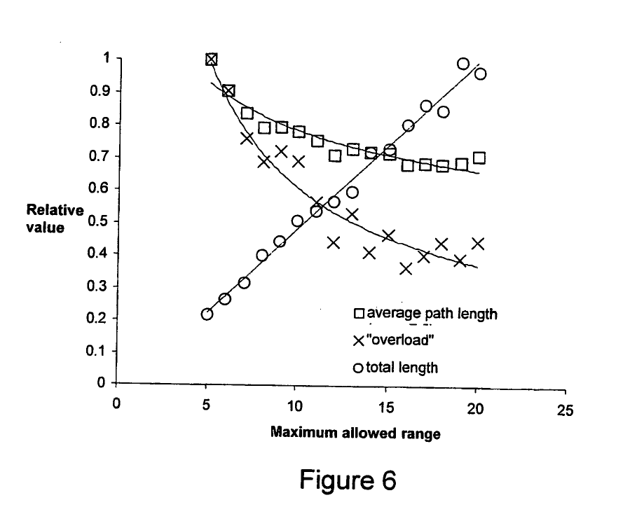

FIG. 6 is a graph illustrating the performance of the process of FIG. 4 in building a network; and

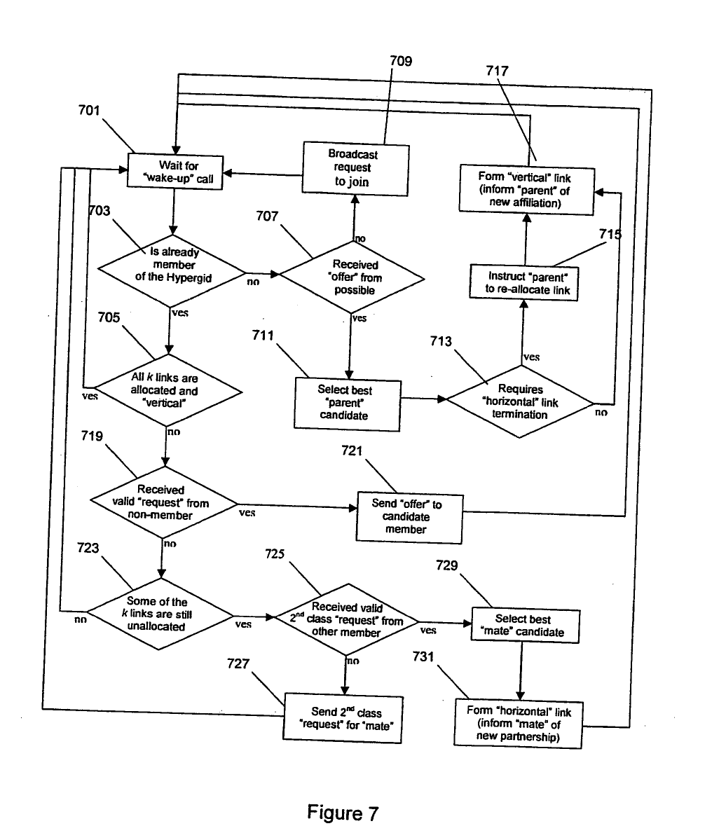

FIG. 7 is a flow chart illustrating the process carried out during the process of nodes joining a network in accordance with another embodiment of the invention.

FIG. 1 is a schematic representation of a prior art network 101 of computers A to Q. The computers A to Q are capable of maintaining the same number (four) of connections as others. This hierarchical network topology is known as a tree, and is formed by new nodes preferentially connecting to the node which has the lowest “height” in the tree and which has a free link. For example, core node (computer A) has “height”=0, then each computer linked to A has a height incremented by 1, for example computer B has “height”=1, computer F has “height”=2, etc. Any new node R (not shown) joining the network, for example by linking to computer F, would then have “height”=3. Later nodes joining the network would preferentially link to any of computers G to Q, rather than R, because they have a lower “height”.

In this type of design, comprising no dedicated routers or relays, connecting from one computer to another over the network 101 involves making a series of connections between similar devices. In the network 101, there is only one route between any two of the computers A to Q. Also, node usage obeys a predictable pattern as long as traffic is homogeneously distributed between all computers A to Q. The closer one comes to the core of the network i.e. computer A, the higher the information flow along the network links.

This traffic pattern means that the core node (computer A) may have to handle 13 times more traffic than its least busy counterparts, computers F to Q. Assuming that all devices A to Q have similar capabilities, the “tree-like” design of network 101 appears susceptible to become overloaded. This demonstrates that imposing an upper limit on node connection (four in this example) does not reduce the chances of network overload. In fact, it appears that the opposite is the case. Adding this one local constraint (originally intended to lower pressure on supposedly limited devices) results in core node A being forced to act as a hub in the network 101.

Detecting that a given node is likely to become a bottleneck may not always be feasible since it is not apparent from the number of connections that a node has. The overload of node A is relatively easy to observe when looking down at the schematic representation of the network 101 in FIG. 1a. However, from the viewpoint of individual nodes in the network, or where no network representation exists, detecting potentially overloaded nodes or bottlenecks is more difficult. For example, in the network 101 nodes A to E all have the same number of first neighbours, so it is not obvious that node A will be liable to be overloaded.

The problem illustrated above with reference to FIG. 1a could easily occur in a network undergoing a decentralised growth process, whereby nodes with available connections advertise for other nodes to join the network. Early members of the network are likely to end up in the position of acting as core relays as later joining members gradually fill up empty spaces on the periphery of the network.

FIG. 1b is a schematic representation of a network 103 in accordance with an embodiment of the present invention. The network 103 comprises interconnected nodes A to Q which is similar to the network of figure la. However, in the network 103 the connection rules for each node have been modified. In addition to each node being constrained by having a maximum number of connections, the peripheral nodes are not allowed to have fewer connections than the more central nodes. This results in the architecture shown in FIG. 1b. The design rules used to produce it specify that nodes should first be arranged in a tree. Then the remaining node connections are cross-allocated at random between peripheral nodes. The result is a network topology with a typically very low clustering coefficient. In other words, the neighbours of a given nodes neighbouring nodes are not neighbours of the given node.

It should be noted that each node in the network stores a variable called “height” which is used to indicate the position of the node in the network tree hierarchy, as discussed for FIG. 1a. When a node joins the network, it sets its own “height” in the tree to that of its new parent plus one. As a result, as soon as a node joins the network it has a well-defined “height” in the hierarchy (the root or first node's “height”=0, root's children's “height”=1, robot's children's children's “height”=2 etc.). Links between nodes having the same height in the network are termed horizontal links (e.g. the link between computers G and P), while links involving a hierarchical relationship are termed vertical links i.e. a parent-child link (e.g. the link between computers G and B).

It will be understood that the concept of height in the tree hierarchy starting at 0 and working upwards has been chosen arbitrarily, and could alternatively started at any other chosen value and/or the numbering of the levels could be in the opposite direction, i.e. with negative incrementation.

The resulting network topology in FIG. 1b has less traffic passing through the core than that of FIG. 1a. In the network 103, node A is part of only twice as many routes as any peripheral node: on average, nodes F to Q are part of approximately 26 such routes, compared to 50 for the “hub” node A. However, in network 101, 208 of the same 17×16=272 directed routes pass through node A.

Advantageously, the relatively homogeneous distribution of the workload shown for the topology of FIG. 1b is maintained in larger systems. FIG. 2 shows the results of simulations for three different network topologies for comparison: a standard tree topology (FIG. 1a on a larger scale); a scale-free network topology; and the topology described above with reference to FIG. 1b on a larger scale. In each case, the operation of a packet-switching network was simulated by each node sending 100 packets to randomly selected other nodes, resulting in the total amount of information exchanged being a linear function of network size. FIG. 2 shows how the traffic through the “hub” node varies with the size of the network (i.e. the number of nodes).

The simulation demonstrated that for a topology of FIG. 1b of degree four (four connections per node), for network sizes up to 1457 nodes, less than 1% of all packets sent along the shortest route will transit through the “hub” (core node). In fact, the simulations showed that the traffic flow through the hub is a logarithmic function of the total number of nodes in the network.

For comparison, a scale-free network topology was also simulated (this is-obtained using the “preferential attachment rule”, whereby the probability of a node to be selected as host by a newcomer is a linear function of the node's degree). This means that some nodes end up having many more connections than others, and since it is a necessary feature of this type of network that the node degree is not fixed consequently it means that it is not possible to create an identically comparable network to that of FIG. 1b . Instead, a “counterpart” network is used in which the network has the same number of nodes and the same total number of connections between the nodes. This showed that the traffic through the “hub” (namely the most highly connected node, since in this type of network it is the closest equivalent to the hub) increased as almost a linear function with the number of nodes (in fact, it increased as a power law with exponent just lower than 1, see FIG. 2). Specifically, for a scale-free network of 1457 nodes and ˜3000 links, almost 20% of traffic is routed through the hub, compared with less than 1% for the network topology of FIG. 1b. However, it should also be noted that the average path length (i.e. the number of hops between two randomly selected nodes) is lower for the scale-free network, 4.53 versus 5.99 for the network topology of FIG. 1b, for networks of 1457 nodes.

Comparing the performance of the network topologies from the simulations above shows that the FIG. 1b topology type, although marginally increasing the average path length, results in a large improvement in scalability. The central nodes do not have to support rapidly increasing traffic as the network grows, which is a major problem for large-scale distributed computing. Also, because in the FIG. 1b topology type, the constraints are exactly the same for any node that joins and at any time in the network's history, the connection rules are simple and easy to apply. These rules can be summarised as follows: in order to join a new node to the network of degree k (i.e. where each node has k connections) then the following steps should be carried out:

1. Identify the node with the lowest height (i.e. the innermost node) in the network that is maintaining horizontal connections (or has unallocated links).

2. If the identified node has no free links, then request one of the horizontal connections to be terminated and reallocated to the joining node, the link becoming vertical in the process.

3. Attempt to initiate k−1 horizontal links between the joining node and other nodes in the network having the same height as the joining node and which are advertising a spare connection.

Once this process is complete, the new node is a member of the network and if the network keeps growing, other layers will gradually form on top of the newly joined node but without adding significantly to the workload of the new node.

In order to compensate for the small increase in traffic that can occur when a node becomes increasingly submerged in the network, then in some embodiments a reward scheme may be implemented. In the scheme, submerged nodes obtain services at an incremental discount dependent on how far the surface of the network has moved away. Indeed, as the network's size grows faster than the workload on nodes, and considering the fact that the very principle of distributed computing is about sharing resources, it may become highly beneficial for a node to be more deeply submerged in the network. This would facilitate the replacement of departing nodes by their former children nodes and initiate a cascade of inward migrations to restore the network's integrity.

Another important feature of network topology design is the resistance of the network to directed attack. The network topologies described above in relation to the scale-free network and the FIG. 1b type network topology have been subjected to simulations of directed attack by the periodic removal of nodes, and the effect that this had on the possible routes through the network noted. FIG. 3a shows the results for the directed attack simulation for the scale-free network topology. As can be seen from the graph, removing the 1% busiest nodes from the intact network has a considerable effect on path length distribution for the scale-free topology. In contrast, FIG. 3b shows the results of the directed attack simulation on the FIG. 1b network topology type. In this case, the change in path length distribution is negligible. Furthermore, the redirected traffic is homogeneously distributed in the FIG. 1b topology type, resulting in the amount of traffic through surviving nodes being virtually unchanged (average ratio after/before attack is ˜1.02, with a maximum of ˜1.41) unlike in the scale-free network (average ratio ˜1.55, maximum ˜6.84).

In the scale-free topology, failure of a main hub can have catastrophic consequences. This is due to the huge amount of traffic which needs to be transferred to secondary relays which simply lack the capability to process it. If overload causes these relays to crash too, it can easily initiate a chain reaction, as increasingly more packets have to be re-routed through increasingly less capable nodes, resulting in what is termed cascade failure. This can have serious implications for network survivability, since it means that the damage caused by malicious targeting of relays can extend far beyond the nodes actually attacked. In contrast, in the FIG. 1b type network topology the homogeneous distribution of traffic across the network makes cascade failure far less likely when re-routing is needed. This is because any node failure will lead to less fluctuation in terms of the relative increase of traffic through surrounding nodes. A further advantage of this topology is that the homogeneous node degree (all nodes have the same number of links to 1^{st} neigbours) means that there is no single node which, once attacked, will provide access to a large number of potential targets.

FIG. 4 is a flow chart illustrating an algorithm for a centralised network management system for connecting nodes to build a FIG. 1b type network. In addition, the algorithm of FIG. 4 takes into account a further criteria, namely the maximum specified rangs for nodes forming horizontal and vertical links. In any network of the FIG. 1b type topology, opposing requirements for the lengths of the links need to be taken into account. On the one hand, short links lead to low deployment costs but a high average path length through the network, whilst on the other hand, long range links allow a low average path length but high deployment costs in terms of physical connections (i.e. a long underground cable, or particularly powerful transmitter for a wireless environment). This is particularly relevant in the case of the horizontal links since these are typically only very short-lived. Therefore, some compromise needs to be reached to satisfy the opposing requirements, and implemented by the network designers by specifiying maximum ranges for horizontal and vertical connections.

FIG. 5 is a sequence of schematic representations of a simulated network being built in in accordance with the algorithm of FIG. 4. The network of FIG. 5 is built on a lattice space of 20×20 cells, with one cell out of four (random distribution) containing a candidate member member (i.e. density=0.25). The first node is randomly chosen among all the candidate members and the entire structure is grown progressively in accordance with the algorithm of FIG. 4.

With reference to FIG. 4, the network management system that initiates the network connection broadcasts a message asking for candidate members which are not yet connected to the network and builds a candidate list from the received replies. At step 401 the first candidate on the list is selected and, at step 403, the system checks that the candidate is within range of a node that is a member of the network. If not, then processing moves to step 405 at which the candidate is returned to the end of the list and another candidate selected at step 401.

If at step 403 the candidate is within range of at least one member node then processing moves to step 407 at which a check is carried out to establish whether at least one of the members in range has fewer than k vertical links (where k is the degree of the network i.e. the maximum allowed number of links per node). If not the processing moves to step 405 and processing continues as described above from that step. If any of the member nodes do have fewer than k vertical links, then at step 409 one of those member nodes is selected as the parent for the candidate node.

At step 411, the parent's links are inspected to establish whether all of its horizontal links are allocated. If all the horizontal links are allocated then processing moves to step 415 where the parent is requested to terminate one of those horizontal links and processing moves to step 413. If at step 411 unallocated horizontal links are identified then processing moves straight to step 413 at which a vertical link is initiated between the candidate node and the parent node. Also, at step 413 the candidate node sets its height to that of the parent plus one, and processing moves to step 417.

At step 417, the system attempts to initiate connection of the remaining k−1 links of the new member (ex-candidate) to form horizontal links with other members of the same level in the network. The connections will be initiated with members selected at random from the nodes which are within a specified range of the new member. Processing then moves to step 419 at which the routing information held in the network is updated to take account of the new member and of the newly formed connections between the nodes. Processing then moves to step 421 where the newly joined node is removed from the candidate waiting list and processing returns to step 401.

FIG. 5 shows a physical schematic of the network (where the term “physical” is used to mean that the location of the nodes in the figure is meant to represent the position of the nodes in real space, not their topological situation). The apparent complexity of the architecture comes from the fact that nodes join in a random order and the entire network is grown while respecting the local constraints mentioned earlier. However from a topological point of view, the apparently highly disorganised network has the same underlying structure as the apparently tidier structure shown on FIG. 1b.

FIG. 6 shows a graph illustrating the performance of the algorithm for building a network described above with reference to FIGS. 4 and 5. Assuming that horizontal links, when re-allocated, can be recycled only if they are long enough to reach their new endpoint, the “cumulative total length” of the network (i.e. the sum of the lengths of all links) is a linear function of the maximum range allowed between 1^{st} neighbours. The average path length is inversely correlated with the same parameter. The graph also shows the variation of a global variable called “overload”. It is based on the assumption that all nodes have identical capabilities and that the traffic should therefore ideally be evenly distributed between them. A network comprising N nodes obviously has N²/2 shortest routes linking all of its members (provided self-targeting is allowed). Each node should therefore ideally not be part of more than N/2 such routes. The “overload” is the proportion of shortest routes that require some of the nodes they are made of to exceed this limit. Exceeding the limit is a cause for node stress and could result in bottlenecks forming in the network, so this complex variable should be kept as low as possible. The fact that it is inversely proportional to maximum allowed range as well suggests that several factors must be considered when looking for a suitable compromise between minimising cost and maximising efficiency in a physical network.

The algorithm described above with reference to FIG. 4 shows the operation of a centralised system which ensures that new nodes join sequentially only if the constraints on the maximum allowed range and link availability are satisfied. If a node is scheduled to join but the right conditions are not met (e.g. the distance to the nearest member is higher than the maximum authorised range), it is transferred to the waiting list. Another as yet unconnected candidate could provide a suitable entry point at a later stage of network development. However, all the connections are made under the control of the centralised network management system. FIG. 7 represents an equivalent algorithm for carrying out essentially the same process in a fully decentralised system. In this arrangement member nodes and candidate nodes negotiate connections independently by exchanging a series of “request” and “offer” messages between each other. In other words there are no centralised decisions.

With reference to FIG. 7, each node sits idle (from the point of view of the connection process) at step 701 until a relevant message is received that activates the process. The node may also be arranged to activate itself at predetermined intervals to carry out a status check or other automated process. When a message is received, processing moves to step 703 at which the node establishes whether or not it is a member of the network (the network might be a physical network or could be some type of overlay network formed on top of an earlier existing network, depending on the circumstances). If the node is a member then processing moves to step 705, in which the node determines whether all of its links are allocated and are vertical. If this is the case then processing returns to step 701 and the node becomes idle again.

If at step 703 the node determines that it is not a member of the network, processing moves to step 707 where it checks whether or not it has received an offer for connection to the network from a prospective parent node. If no such offer has been received then processing moves to step 709 where the node broadcasts a request to join the network and then becomes idle again at step 701 to await any replies. Any such reply would bring the process from step 701 to step 707 at which processing would then move on to step 711. At step 711 the node chooses one of the offers received to join the network by selecting the parent which has the lowest “height” in the network and which is within the maximum allowed range for vertical links (the range could be defined in any suitable manner, for example, either in terms of the physical distance between the nodes, or alternatively in the case of an overlay network using the pinging delay or the number of links of the underlying network between the nodes in IP address space).

At step 713 the node determines whether the parent needs to terminate one of its horizontal links in order to provide a connecting point for the node, and if this is the case processing moves to step 715 where the request to terminate that link is made to the parent. The parent node initiates a process with the node to which the terminated link was connected to inform that other node of that termination, and processing moves on to step 717. If at step 713 a free link is identified then processing moves straight to step 717. At step 717 the connection is made between the joining node and the parent, and the newly joined node sets its height to that of the parent plus one. Processing then returns to step 701.

If at step 705 the node determines that it does not have k vertical links then processing moves to step 719 where it checks to see if a request to join the network has been received from a non member. If this is the case then processing moves to step 721 where an offer for connection is sent to the requesting node and processing returns to step 701 to await any response. If at step 719 no requests have been received then processing moves to step 723 where the node check whether or not any of its k links are unallocated and if not processing returns to step 701. If however links do remain unallocated then processing moves to step 725.

At step 725 the node checks to see if it has received any requests to form a horizontal connection from other members of the network. Such requests are treated with a lower priority (second class) than requests from non members i.e. a request for a parent node (first class requests). If no such low priority requests have been received then processing moves to step 727 where the node broadcasts a horizontal connection request to the other nodes in the network (a second class request) and processing returns to step 701 to await any reply. If at step 725 low priority requests have been received then processing moves to step 729. If there are more than one canditate nodes which have sent horizontal connection requests, then at step 729 one of the candidates is selected. This selection might be completely at random, or might firstly limit the number of candidates depending on their ranges from the node (where range can be, for example, physical distance, pinging delay or number of links to the node in an underlying network topology) before then selecting at random. Processing then moves to step 731 where a horizontal link is initiated with the other node (mate) and processing returns to step 701 to the idle state.

It is understood that the nodes and systems described earlier, including the methods for connecting nodes in a network are applicable to many types of network. For example, the methods might be used as a connection protocol for generating a virtual network independently of the supporting media and of the actual topology of the physical layer (i.e. organise hyperlinks). The system might alternatively be used to create and manage a physical network such as a small to medium sized network (in terms of surface), perhaps featuring high component density and turnover. The system could be used in conjunction with adaptive topology to ensure that the cost of rewiring is maintained within acceptable limits (due to the limited spatial extension of the system). Possible examples of such networks could include highly dynamic local area networks where resources have to be shared but dedicated servers/routers are not considered an option or “junk” supercomputing facilities with high failure rate of component parts.

Both arrangements above can be implemented using network cards fitted with a number of sockets similar to the intended degree of the network. Cables can then simply be plugged and un-plugged as components are added to, transferred within or removed from the network. Adding a new piece of hardware is effected by locating an available entry point in the vicinity of the new device (unplugging and reallocating a “horizontal” cable if necessary) then plugging up to k−1 open-ended cables of the same topological layer into the new device's network card. Alternatively, programmable hardware can be used which would allow reconfiguring network topology without having to physically manipulate operational connections to restore system integrity.

It will be understood by those skilled in the art that the apparatus that embodies the invention could be a general purpose device having software arranged to provide an embodiment of the invention. The device could be a single device or a group of devices and the software could be a single program or a set of programs.

Furthermore, any or all of the software used to implement the invention can be contained on various transmission and/or storage mediums such as a floppy disc, CD-ROM, or magnetic tape so that the program can be loaded onto one or more general purpose devices or could be downloaded over a network using a suitable transmission medium.

Unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. A node for a network, the network comprising a hierarchical structure in which a node is considered to be at a higher level than a parent node to which it connects when joining the network, the node being adapted to: (a) maintain a primary connection to a node at a lower level in the network hierarchy; (b) to attempt to maintain a specified number N of further connections between the node and other nodes in the network; and (c) upon receipt of a request from a further node desiring to form its primary connection with the node, and in the event that none of the N connections of the node is unallocated, then to: select one of the further connections which is not a primary connection for one of the other nodes; and to re-allocate that selected further connection to the further node so as to form the primary connection for the further node.

2. A node according to claim 1, wherein step (b) comprises the node forming one or more connections with other nodes on the same level in the network as the node.

3. A node according to claim 1, further adapted to attempt to maintain the specified number of N further connections between the node and other nodes in the network by periodically carrying out the following step: for each unallocated one of the N connections, selecting a node from one or more candidate nodes, and forming a connection with the selected node, until either the N further connections have been successfully completed or there are no more candidate nodes.

4. A node according to claim 3, wherein the step of selecting the peer node comprises selecting at random from the one or more candidate nodes.

5. A node according to claim 3 on, wherein the step of selecting the node comprises selecting on the basis of the range of the candidate nodes to the node.

6. A node according to claim 5, wherein the network comprises an overlay network formed over an underlying network of nodes, and wherein the range between a candidate node and the node comprises the number of links between them in the underlying network.

7. A node according to claim 1, further adapted to join the network by performing the steps of: selecting a parent node from one or more prospective parent nodes of the network, wherein the selected parent node is the node which is lowest in the network hierarchy; and joining the network by forming a primary connection to the selected parent node.

8. A node according to claim 7, further adapted to identify an other node as a prospective parent node on the basis of the range of the other node to the node.

9. A node according to claim 7, further adapted to identify an other node as a prospective parent node if it is within a specified range of the node.

10. A node according to claim 1, further adapted, in the event that the primary connection fails, to re-establish a primary connection with another node which is at a lower level in the network hierarchy than the node.

11. A network, comprising a plurality of nodes each according to claim 1, in which the specified number N of connections is substantially the same for every node.

12. A method of operating a node in a network, the network comprising a hierarchical structure in which a node is considered to be at a higher level than a parent node to which it connects when joining the network, the method comprising: (a) maintaining a primary connection to a node at a lower level in the network hierarchy; (b) attempting to maintain a specified number N of further connections between the node and other nodes in the network; and (c) upon receipt of a request from a further node desiring to form its primary connection with the node, and in the event that none of the N connections of the node is unallocated, then: selecting one of the further connections which is not a primary connection for one of the other nodes; and re-allocating that selected further connection to the further node so as to form the primary connection for the further node.

13. A method according to claim 12, wherein step (b) comprises the node forming one or more connections with other nodes on the same level in the network as the node.

14. A method according to claim 12, in which the step of attempting to maintain the specified number of N further connections to the other nodes in the network comprises periodically carrying out the following step: for each unallocated one of the N connections, selecting a node from one or more candidate nodes, and forming a connection with the selected node, until either the N further connections have been successfully completed or there are no more candidate nodes.

15. A method according to claim 13, in which the step of selecting the peer node comprises selecting at random from the one or more candidate nodes.

16. A method according to claim 14, wherein the step of selecting the node comprises selecting on the basis of the range of the candidate nodes to the node.

17. A method according to claim 16, wherein the network comprises an overlay network formed over an underlying network of nodes, and wherein the range between a candidate node and the node comprises the number of links between them in the underlying network.

18. A method according to claim 12, further comprising the step of joining the network by performing the steps OF: selecting a parent node from one or more prospective parent nodes of the network, wherein the selected parent node is the node which is lowest in the network hierarchy; and joining the network by forming a primary connection to the selected parent node.

19. A method according to claim 18, comprising identifying an other node as a prospective parent node on the basis of the range of the other node to the node.

20. A method according to claim 18, comprising identifying an other node as a prospective parent node if it is within a specified range of the node.

21. A method according to claim 12, further comprising the step of, in the event that the primary connection fails, re-establishing a primary connection with another node which is at a lower level in the network hierarchy than the node.

22. A method of operating a network which comprises a plurality of nodes, the method comprising performing for every node the method according to claim 12, and in which the specified number N of connections is substantially the same for every node.

23. A computer program comprising instructions for causing one or more processors to operate as the node according to claim 1 when the instructions are executed by the processor or processors.

24. A storage medium carrying computer readable code representing instructions for causing one or more processors to operate as the node according to claim 1 when the instructions are executed by the processor or processors.

25. A computer data signal embodied in a carrier wave and representing instructions for causing one or more processors to operate as the node according to claim 1 when the instructions are executed by the processor or processors.

26. A computer program comprising instructions for causing one or more processors to perform the method according to claim 12 when the instructions are executed by the processor or processors.

27. A storage medium carrying computer readable code representing instructions for causing one or more processors to perform the method according to claim 12 when the instructions are executed by the processor or processors.

28. A computer data signal embodied in a carrier wave and representing instructions for causing one or more processors to perform the method according to claim 12 when the instructions are executed by the processor or processors.
